(19) United States
(12) Patent Application Publication
(10) Pub. No.: US 2008/0319894 A1
(43) Pub. Date: Dec. 25, 2008

(54) PURCHASING OF INVESTMENT PROPERTY BY WAY OF HAVING AN ADVANCED LEASE OPTION OR RENT TO OWN TENANT CHOOSE HIS OWN PROPERTY

(75) Inventor: Steven Alan Karklin, Solon, OH (US)

Correspondence Address: DRIGGS, HOGG, DAUGHERTY & DEL ZOPPO CO., L.P.A., 38500 CHARDON ROAD, DEPT. DLBH, WILLOUGBY HILLS, OH, 44094, US

(73) Assignee: SPS PARTNERS LLC, Mayfield Village, OH (US)

(21) Appl. No.: 11/848,731

(22) Filed: Aug. 31, 2007

Related U.S. Application Data
(60) Provisional application No. 60/945,631, filed on Jun. 22, 2007.

(51) Int. Cl. G06Q 40/00; G06F 17/30; G06F 17/40; G06Q 50/00; G06Q 20/00

(52) U.S. Cl. 705/38; 705/35; 705/39; 705/400

(57) ABSTRACT

A method described herein includes receiving an indication that a prospective purchaser wishes to purchase a property identified by the purchaser by way of a lease-option or lease-purchase agreement. The method additionally includes purchasing the identified property in response to receiving the indication, and providing the prospective purchaser with a lease option or lease purchase agreement with respect to the identified property.

### REFERENCE TO RELATED APPLICATION

This application claims the benefit of U.S. Provisional Patent Application Ser. No. 60/945,631, filed on Jun. 22, 2007, and entitled INDIVIDUALIZED RENT-TO-OWN PROPERTIES. The entirety of this application is incorporated herein by reference.

### BACKGROUND

Owning a home is thought of as a part of the “American Dream.” Conventionally, a prospective home owner obtains a mortgage loan from a lender; in some instances, however, a prospective purchaser will not qualify for a mortgage loan. For instance, an individual may have filed for bankruptcy a few years prior to applying for a mortgage loan. Lease option, rent to own, and lease purchase agreements have been developed to allow individuals to purchase a home when they otherwise may not qualify for a conventional mortgage loan. Lease option and rent to own agreements generally include terms relating to an option consideration or other deposit, terms for periodic lease, an option term, use of the property as a lessee, and an option to purchase the property at the exercise price for the duration of the option period. Some of the periodic payment may be applied as a credit to the exercise price. Terms are typically memorialized in one or more written agreements that spell out the material terms. Lease purchase agreements are similar, but the buyer is obligated to purchase the property at the end of the period (not option period).

For a prospective purchaser to purchase property (e.g., a single family residence) by way of a lease option and/or lease purchase, the prospective purchaser conventionally searches for properties that are held out as being available for sale by way of lease option and/or lease purchase. Typically, the number of properties available by way of lease option and/or lease purchase is relatively limited, and the properties are often in relatively limited geographic areas. Often, the available properties do not correlate with the prospective purchaser's preferences with respect to various aspects of properties, including style of a house, size of a lot, location, etc.

With respect to an investor, the process of purchasing and selling a property that is to be sold by way of lease option and/or lease purchase involves numerous steps. The investor searches for and then procures the property at a price where the investor can make a reasonable profit, makes repairs to the property, and advertises to sell the property by way of a lease-option and/or lease-purchase agreement. The property remains vacant until a prospective purchaser (by way of lease-option and/or lease-purchase) shows interest in the property, and the prospective purchaser is thereafter screened. If the prospective purchaser passes the screening process, the prospective purchaser is provided with a lease-option and/or lease purchase agreement with respect to the property.

### SUMMARY

Those skilled in the art will appreciate still other aspects of the present application upon reading and understanding the attached figures and description.

According to an aspect a method described herein includes receiving an indication that a prospective purchaser wishes to purchase a property identified by the purchaser by way of a lease-option or lease-purchase agreement. The method also includes purchasing the identified property in response to receiving the indication and providing the prospective purchaser with a lease option or lease purchase agreement with respect to the identified property.

According to another aspect, a method includes receiving over a network financial data of a prospective purchaser of a property and using an algorithm that is executed on a computer to determine an offer price, wherein the offer price is based at least in part upon the received financial data. The method additionally includes receiving an identification of a property from the prospective purchaser, wherein an offer price of the property is at or below the determined offer price, purchasing the property in response to receiving the identification of the property, and providing the prospective purchaser with a lease-option or lease-purchase agreement for the property.

According to yet another aspect, a method includes receiving a price range for properties for a prospective purchaser from a lessor, showing the prospective purchaser properties that are in the price range, receiving, from the prospective purchaser, an identity of at least one property that is desirably purchased by way of lease-option or lease-purchase, and identifying to the lessor the at least one property.

According to still another aspect, a method includes evaluating a credit history of a prospective purchaser or a property, determining a mortgage loan amount the prospective purchaser will qualify for at a time in the future if certain contingencies are met, providing the determined mortgage amount to a lessor, wherein the lessor agrees to sell the property to the prospective purchaser by way of a lease option or lease purchase agreement, and providing a mortgage loan to the prospective purchaser when the prospective purchaser qualifies for the mortgage loan.

According to yet another aspect, a method includes receiving financial data from a prospective purchaser of a single family residence, wherein the prospective purchaser wishes to purchase a single family residence by way of a lease option or lease purchase agreement and the financial data includes an amount of a deposit the prospective purchaser can afford to put down and a periodic payment the prospective purchaser can afford to make. The method also includes providing the prospective purchaser with an offer price, wherein the prospective purchaser may search for single family residences that are at or below the offer price, and receiving an identity of one or more single family residences from the prospective purchaser. The method additionally includes executing and delivering a term sheet to the prospective purchaser, wherein terms of the term sheet include an amount of a deposit required from the prospective purchaser, receiving a deposit that accords to the terms of the term sheet, and purchasing one of the identified single family residences. Moreover, the method also includes executing and delivering a lease agreement for the identified single family residence, executing and delivering an option agreement for the identified single family residence, receiving a purchase price for the identified single family in accordance with terms of the option agreement, and transferring title of the single family residence to the prospective purchaser.

### BRIEF DESCRIPTION OF THE DRAWINGS

FIG. 1 is a diagram that illustrates purchase of a property by way of a lease option or lease purchase agreement.

FIG. 2 is a diagram that illustrates purchase of a property by way of a lease option or lease purchase agreement.

FIG. 3 is a diagram that illustrates purchase of a property by way of a lease option or lease purchase agreement.

FIG. 4 is a diagram that illustrates purchase of a property by way of a lease option or lease purchase agreement.

FIG. 5 is a function block diagram of a system that facilitates determining price data for a prospective purchaser of a property.

FIG. 6 is a representative flow diagram illustrating a method for providing a purchaser with a lease option or lease purchase agreement.

FIG. 7 is a representative flow diagram illustrating a method for providing a purchaser with a lease option or lease purchase agreement.

FIG. 8 is a representative flow diagram illustrating a method for providing a purchaser with a lease option or lease purchase agreement.

FIG. 9 is a representative flow diagram illustrating a method that relates to a lease option or lease purchase agreement.

FIG. 10 is a representative flow diagram illustrating a method that relates to a lease option or lease purchase agreement.

### DETAILED DESCRIPTION

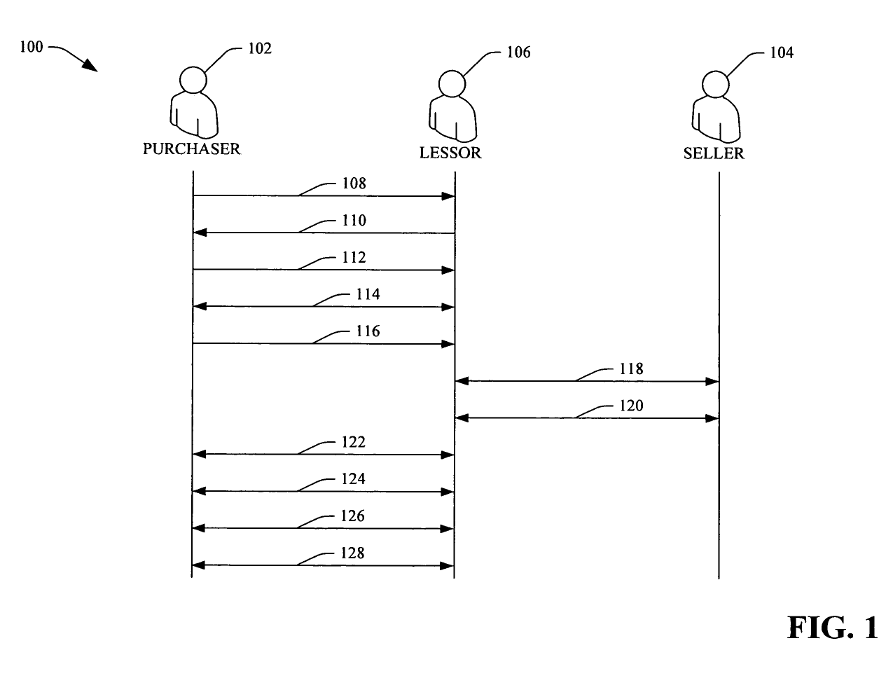

With reference to FIG. 1, a diagram 100 is provided that illustrates interaction amongst a prospective purchaser 102 of a property, a seller 104 of the property, and a lessor 106 with respect to the purchase of a property by the purchaser 102 by way of a lease option or lease purchase agreement. For instance, the property that is desirably bought by the purchaser 102 may be real property, which may include land, a building such as a single family residence (e.g., house, condominium, . . . ), a house with four or less rentable units, and/or other entities commonly associated with real property. In another example, the property may be personal property, such as an automobile. Furthermore, the lessor 106 can be an investor, a realtor, a real-estate company, a lender, or other suitable party.

At 108, the purchaser 102 approaches the lessor 106 with respect to buying a property from the lessor 106 by way of a lease option or lease purchase agreement. For instance, the purchaser 102 may be referred to the lessor 106 by a realtor, a mortgage broker, a lender, or other entity. Also at 108, the purchaser 102 provides the lessor 106 with data relating to the desired purchase of property. This data includes financial data, such as an amount of a deposit the purchaser 102 can afford and a monthly lease amount the purchaser 102 can afford to pay. The data may also include one or more regions where the purchaser 102 desires to live, annual income of the purchaser 102, contact information of the purchaser 102, current living arrangement (e.g., whether the purchaser 102 rents or owns their current residence), number of bedrooms and/or bathrooms in a desirable property (if searching for a home), a desired data of possession of a property, and other relevant data.

The lessor 106 receives the data and at 110 provides the purchaser 102 with price data, such as an offer price, which can be used as a guidepost when the purchaser 102 searches for properties. For instance, the price data may include an offer price (the price at which a property is being offered or listed for sale), such as a listing price for a single family residence, wherein the purchaser 102 is instructed to search for properties that are at or below the offer price. In another example, the price data may include a price range, wherein the purchaser 102 is instructed to search for properties that are within the price range. The price data can be determined based at least in part upon the data provided by the purchaser 102 to the lessor 106 at 108. The price data may also be determined based upon an expected loan amount the purchaser 102 will be able to obtain at the end of an option term (e.g., two years) if one or more contingencies are met (e.g., payment of credit card bills on time over the course of a year). In addition, the price data may be determined based upon a profit that the lessor 106 expects to make upon selling a property to the purchaser 102 upon execution of a lease option and/or cash flow criteria based upon periodic lease payments.

Once the purchaser 102 has received the price data, the purchaser 102 may begin to search for properties that conform to the price data. For instance, the purchaser 102 may begin searching for properties in the specified region that are at or below a specified offer price. In another example, the lessor 106 may instruct the purchaser 102 to identify three properties at or below the specified offer price. At 112, the purchaser provides the lessor 106 with identities of one or more properties that the purchaser 102 desires to purchase by way of a lease option or lease purchase agreement. For instance, the purchaser 102 may provide the lessor 106 with three properties that meet subjective criteria of the purchaser 102 and that accord to the price data provided by the lessor 106 at 110. In this example, one of the properties identified by the purchaser 102 is owned by the seller 104. Therefore, the lessor 106 offloads searching for houses to the purchaser 102 and the purchaser 102 is able to search for their own home.

Prior to negotiating with sellers of properties identified by the purchaser 102, at 114 the lessor 106 executes a term sheet and delivers the term sheet to the purchaser 102. Similarly, the purchaser 102 executes a term sheet and delivers the term sheet to the lessor 106. Key terms of the term sheet may include an amount of a deposit required and a notice that the deposit is non-refundable unless a property identified by the purchaser 102 cannot be procured by the lessor 106. In an example, the deposit is approximately three times a monthly lease payment as defined by the purchaser 102. Another term of the term sheet may relate to the purchaser 102 agreeing to lease a property upon the property being purchased by the lessor 106. At 116 the purchaser 102 provides the lessor 106 with a deposit in accordance with the term sheet. If the purchaser 102 is unable to locate a property that both meets their subjective criteria that accords to the price data provided by the lessor 106, the purchaser 102 may increase the amount of their deposit provided to the lessor 106. The increase in the amount of the deposit corresponds with an increase in a price of a property that the purchaser 102 may search for.

At 118, the lessor 106 negotiates with the seller 104 of the property identified by the purchaser 102 to purchase the property. It is to be understood that the lessor 106 may negotiate with the seller of each property identified by the purchaser 102 in order to satisfy cash flow criteria and obtain a reasonable profit at the end of the option term, for example. Furthermore, the lessor 106 perform due diligence with respect to properties identified by the purchaser 102. For instance, the lessor 106 may inspect the structural integrity of properties identified by the purchaser. At least a portion of the deposit provided by the purchaser 102 may be used as earnest money for the purchase of a property identified by the purchaser 102. If the seller 104 does not sell the property to the lessor 106, the lessor 106 returns the deposit to the purchaser 102. At 120, the seller 104 sells the property to the lessor 106. At least a portion of the deposit provided by the purchaser 102 may be used by the lessor 106 in connection with purchasing the property from the seller 104 (e.g., as a down payment). Purchase of the property by the lessor 106 from the seller 104 may include presentation, execution, and deliverance of a written purchase agreement to buy the property from the seller 104. Purchase of the property also includes transfer of title of the property to the lessor 106 and transfer of a purchase price to the seller 104.

At 122, a written lease option or lease purchase agreement is executed by the purchaser 102 and the lessor 106 and delivered to the purchaser 102 and the lessor 106. At 124, possession of the property is delivered to the purchaser 102 and the purchaser 102 makes payments to the lessor 106 in accordance with obligations of the written lease agreement. While in possession of the property, the purchaser 102 may be contractually obligated to pay for repairs to the property, utilities, and insurance on the property, and/or real estate taxes on the property. As the purchaser 102 has searched for the property to be purchased and desires to receive possession of the property, the risk of the property remaining vacant is minimized to the lessor 106. At 126, when the purchaser 102 executes a purchase option in the lease option agreement or when the lease period expires in a lease purchase agreement, a written contract is executed and delivered for purchase of the property by the purchaser 102. At 128, closing occurs and title of the property is transferred from the lessor 106 to the purchaser 102, and a purchase price is transferred from the purchaser 102 to the lessor 106.

While the above transaction was described as using a collection of single agreements/contracts, it is to be understood that several agreements/contracts may be used in different cases to achieve a similar result. In addition, for the sake of brevity, various steps described in connection with FIG. 1 are omitted when describing similar transactions.

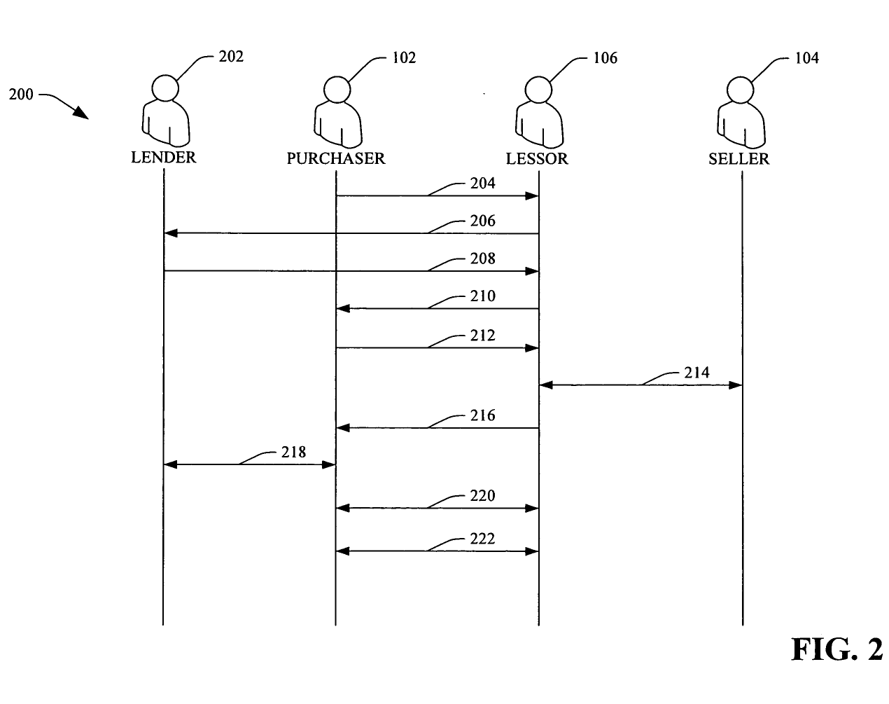

Turning now to FIG. 2, a diagram 200 illustrating an example transaction in accordance with aspects described herein is shown. In this example, the lessor 106 may be an investor or a real estate company. A lender 202 (or mortgage broker or other suitable banking entity) is a fourth party in the transaction. At 204, the purchaser 102 provides data for use in purchasing a property by way of a lease option or lease purchase agreement. At 206, the lessor 106 provides at least a portion of the data to the lender 202, which uses the data to determine an amount of a loan the purchaser 102 will qualify for, for instance, after passage of a certain period of time and upon meeting specified contingencies. At 208, the loan amount, the time period, and/or the contingencies are provided to the lessor 106. The lessor 106 uses at least a portion of the information provided by the purchaser 102 and at least a portion of the information provided by the lender 202 to determine price data relating to the purchaser 102. As noted above, the price data may be a maximum offer price for properties, such that the purchaser 102 may search for houses at or below the maximum offer price. At 210, the price data is provided to the purchaser 102 by the lessor 106.

The purchaser 102 then searches for properties in accordance with the price data (and their own subjective criteria), and provides the lessor 106 with one or more properties that they wish to purchase by way of a lease option or lease purchase agreement. At 212, the purchaser 102 identifies one or more properties that the purchaser wishes to purchase by way of a lease option or lease purchase agreement and provides the identity(s) to the lessor 106. In addition, the purchaser 102 provides the lessor 106 with a deposit.

At 214, the lessor 106 negotiates with the seller 104 and purchases the property. Prior to the seller 104 agreeing to sell the property to the lessor 106, the purchaser 102 may obtain a refund on the deposit. At 216, the lessor 106 provides the purchaser 102 with a lease option or lease purchase agreement. The purchaser 102 then takes possession of the property and makes lease payments to the lessor 106 in accordance with the terms of the lease option or lease purchase agreement. At 218, the purchaser 102 obtains approval from the lender 202 for a loan that allows the purchaser 102 to purchase the property from the lessor 106 in accordance with terms of the lease option or lease purchase agreement. At 220 the purchaser exercises the lease option or purchases the property in accordance with terms of the lease purchase (e.g., by paying monies to the lessor 106 that are loan proceeds from the lender 202). At 222 the lessor 106 sells the property to the purchaser 102 in accordance with the terms of the lease option or lease purchase agreement.

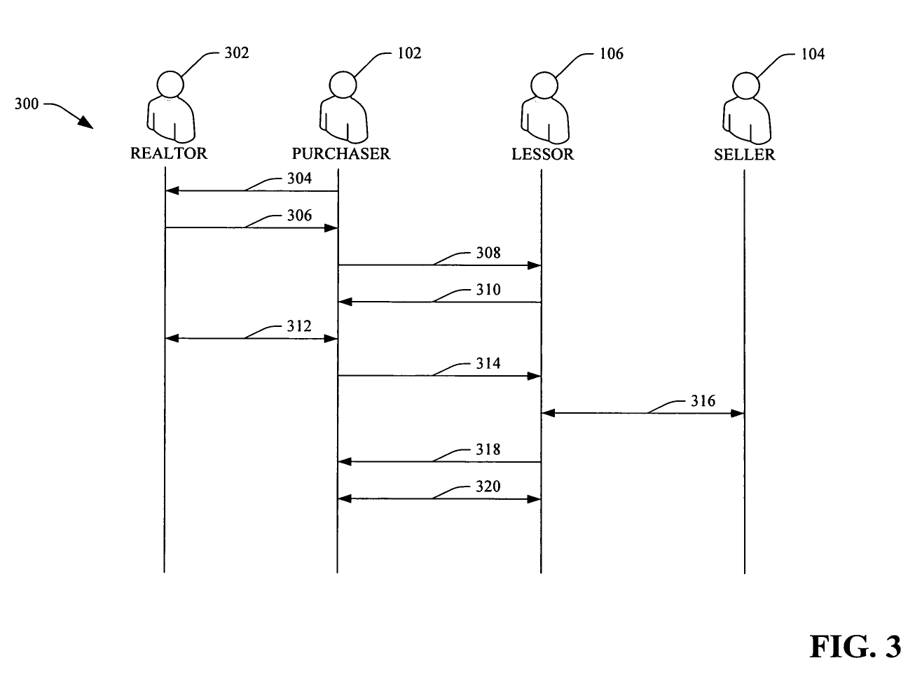

Now referring to FIG. 3, a diagram 300 illustrating an example transaction in accordance with aspects described herein is provided, wherein a realtor 302 acts as a fourth party in the transaction. In this example, the lessor 106 may be an investor or a lender. At 304, the purchaser 102 contacts the realtor 302 with respect to purchasing a home. At 306, the realtor 302 refers the purchaser 102 to the lessor 106. For instance, the purchaser 102 may inform the realtor 302 that they are searching for a property to purchase by way of a lease option or lease purchase agreement. In another example, the realtor 302 may determine that the purchaser 102 does not currently qualify for a loan with respect to a price range that is desired by the purchaser 102.

At 308, the purchaser provides the lessor 106 with data relating to the purchase of a property, including but not limited to financial data. At 310, the lessor 106 provides the purchaser 102 with price data, which informs the purchaser 102 of an offer price of properties that can be searched for by the purchaser 102, for example. At 312, the realtor 302 shows the purchaser 102 homes that are for sale at a price that conforms to the price data provided by the lessor 106. At 314, the purchaser 102 provides the lessor 106 with an identity of at least one property that the purchaser 102 desires to purchase, wherein the identified property has an offer price that accords to the price data provided to the purchaser 102 by the lessor 106. The purchaser 102 also provides the lessor 106 with a deposit. At 316, the lessor 106 purchases the identified property from the seller 104. The lessor may also utilize the services of the realtor 302 during this transaction. The realtor 302 may be provided with a sales commission after the lessor 106 purchases the property from the seller 104, and thus monetizes a client that the realtor 302 heretofore was not able to monetize.

At 318, the lessor 106 provides the purchaser 102 with a lease purchase or lease option agreement for the property, and the purchaser 102 takes possession of the property. The purchaser 102 makes lease payments to the lessor 106 as per the terms of the lease option or lease purchase agreement. At 320, the purchaser 102 purchases the property from the lessor 106. For instance, the purchaser 102 may exercise the option in the lease option agreement.

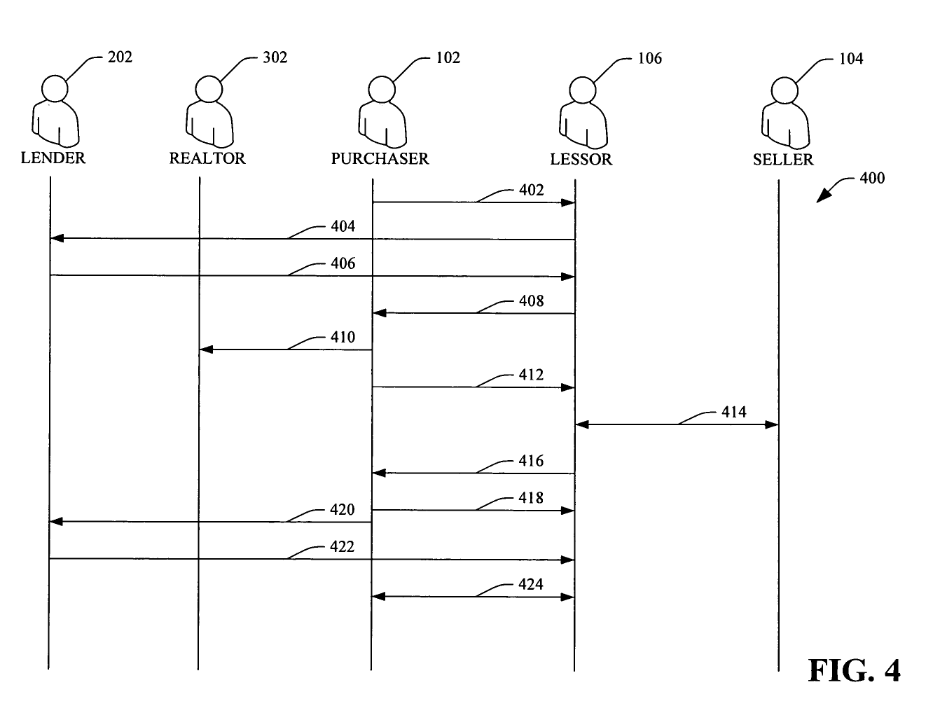

Referring now to FIG. 4, a diagram 400 illustrating an example transaction that includes the purchaser 102, the seller 104, the lessor 106, the lender 202, and the realtor 302 is provided. In this example, the lessor 106 may be an investor, for example. At 402, the purchaser 102 approaches the lessor 106 with regards to purchasing a property by way of a lease option or a lease purchase agreement. For instance, the purchaser 102 can provide the lessor 106 with data that relates to their ability to purchase a property and/or make payments on a lease, such as financial data. At 404, the lessor 106 provides information to the lender 202 relating to the purchaser 102, which may include a subset of the information that is provided to the lessor 106 by the purchaser 102. The lender 202 evaluates credit history of the purchaser 102 and, for instance, determines an amount of a mortgage that the purchaser 102 will qualify for after a certain period of time if particular contingencies are met. The lender 202 thus can create a relationship and future loan with a client they otherwise would not have while also generating a payment history of the purchaser 102, thereby easing the ability to get them a loan at some future time. At 406, the lender 202 provides the mortgage information to the lessor 106.

The lessor 106 evaluates the mortgage information provided by the lender 202, the data provided by the purchaser 102, and/or other relevant data (e.g., property sales trends in areas of interest to the purchaser) and at 408 provides the purchaser 102 with price data, wherein the price data may indicate an offer price of properties. For example, the purchaser 102 may be instructed to search for properties with offer prices at or below an offer price provided by the lessor 106.

At 410 the purchaser 102 contacts the realtor 302, and the realtor 302 shows properties to the purchaser that have offer prices that conform to the price data provided by the lessor 106. The purchaser 102 identifies one or more properties that the purchaser 102 is interested in purchasing, and identifies the one or more properties to the lessor 106 at 412. Also at 412, the purchaser 102 can provide the lessor 106 with a deposit, which may be at least partially supplied to the seller 104 upon the seller 104 agreeing to sell the property to the lessor 106. At 414, the lessor 106 negotiates with the seller 104 of the property and purchases the property. As noted above, the lessor 106 may negotiate a purchase price with the seller 104 based upon pre-defined profit criteria for the lessor 106.

At 416, the lessor 106 provides the purchaser 102 with a lease option or lease purchase agreement with respect to the property. The purchaser 102 may take possession of the property and make lease payments to the lessor 106 in accordance with the lease option or lease purchase agreement. The amount of the lease payments may accord to predefined cash return criteria of the lessor 106. At 418, the purchaser 102 notifies the lessor 106 that the purchaser 102 desires to exercise the option in the lease option agreement or purchase the property from the lessor 106 in accordance with the lease purchase agreement. At 420 the purchaser 102 receives a loan from the lender 202 (e.g., a loan similar to the loan described at 404). The proceeds of the loan are provided to the lessor 106 at 422—accordingly, the lessor 106 sells the property to the purchaser at 424.

While the above diagrams illustrates particular actions occurring in a certain order, it is to be understood that some actions may occur in different orders while still falling under the scope of the hereto-appended claims. Additionally, other actions besides those illustrated in the diagram may occur.

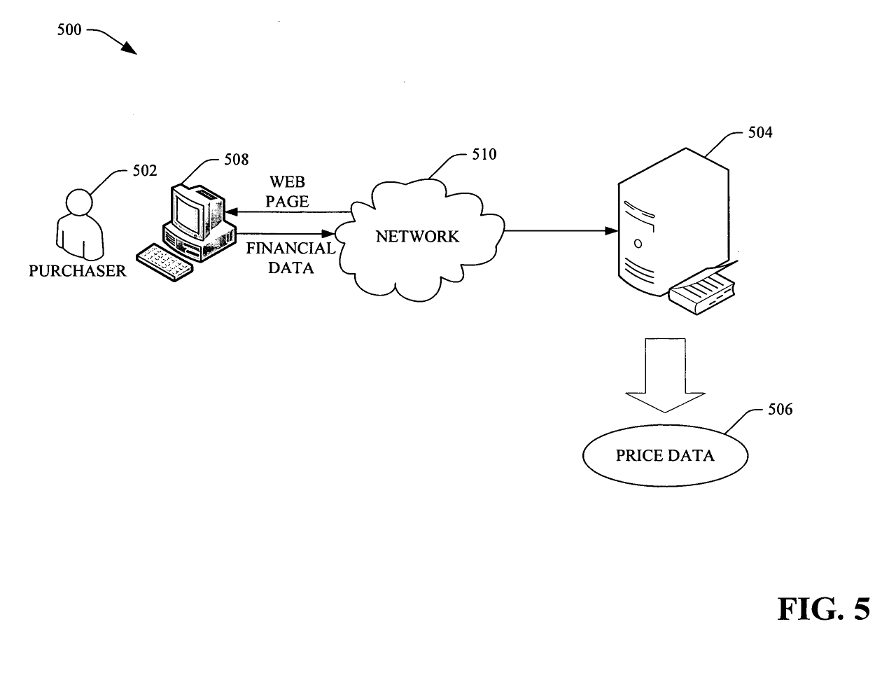

With reference now to FIG. 5, an example system 500 that can be used in connection with determining price data with respect to a property desirably purchased by a purchaser 502 by way of lease option or lease purchase agreement. The system 500 includes a server 504 that, for instance, hosts a web page. The web page hosted by the server includes fields that can be filled with data by a user. For instance, the fields can be configured to receive financial information of the purchaser 502, such as an amount of a deposit the purchaser 502 will make towards a property and a periodic lease payment that the purchaser 502 is able to pay. The web page may also include fields that are configured to receive personal information relating to the purchaser 502, such as the purchaser's current location, a region where the purchaser desires to purchase a property, number of rooms, bedroom, bathrooms, amenities like fireplaces, finished basement, lot size, etc, as well as contact information, etc. Still further, the web page may include fields that are configured to receive personal information (such as a social security number and name) which can be used to evaluate a credit history of the purchaser 502.

The server 504 also includes logic (e.g., an algorithm) for outputting price data 506 with respect to a lease option property purchase or a lease purchase property purchase. For instance, based upon various data, the algorithm in the server 504 can output a maximum offer price for properties with respect to a particular purchaser, wherein the purchaser may search for properties at or below the maximum offer price. The various data may include at least a subset of data that is provided in a field of the web page, together with other information, such as sales trends in a particular market, credit history, etc.

The system 500 additionally includes a computer 508 and a network 510 that is used to transfer data between the server 504 and the computer 508. The computer 508 is used by the purchaser 502 to transmit data to the server 504 and to receive data from the server 504. The network 510 may be, for instance, the Internet, an intranet, or other suitable network. In operation, the purchaser 502 uses the computer 508 and the network 510 to access the web page on the server 504. The purchaser 502 enters information, such as financial data and/or requested house data, into fields of the web page and submits the information to the server 504 by way of the network 510. The requested house data may include desired geographic and house attribute data of a prospective purchaser of a property, such as size of a house, number of bedrooms, number of bathrooms, size of a desired lot, etc. For instance, the purchaser 502 may depress a graphical icon on the web page to submit the information. The server 504 receives the information and an algorithm stored thereon executes using at least a portion of the received information to generate the price data 506. The price data 506 may optionally be provided to the purchaser 502 by way of the network 510 and presented to the purchaser 502 on a display screen of the computer 508. Additionally or alternatively, the price data 506 may be stored in the server 504 or other suitable computer-readable medium.

While the server 504 is described as both hosting the web page and retaining the algorithm, it is to be understood that one server may host the web page while a different server retains the algorithm. Moreover, the algorithm may use data in addition to data provided by the purchaser 502 when outputting the price data 506. In another example, the algorithm may be executed in parallel on different servers. Furthermore, the web page has been described above as using fields to allow the purchaser 502 to provide information relating to the purchase of a property. It is to be understood, however, that a web page in accordance with aspects described herein may use various techniques to collect data from a user, such as radio buttons, slide bars, and the like.

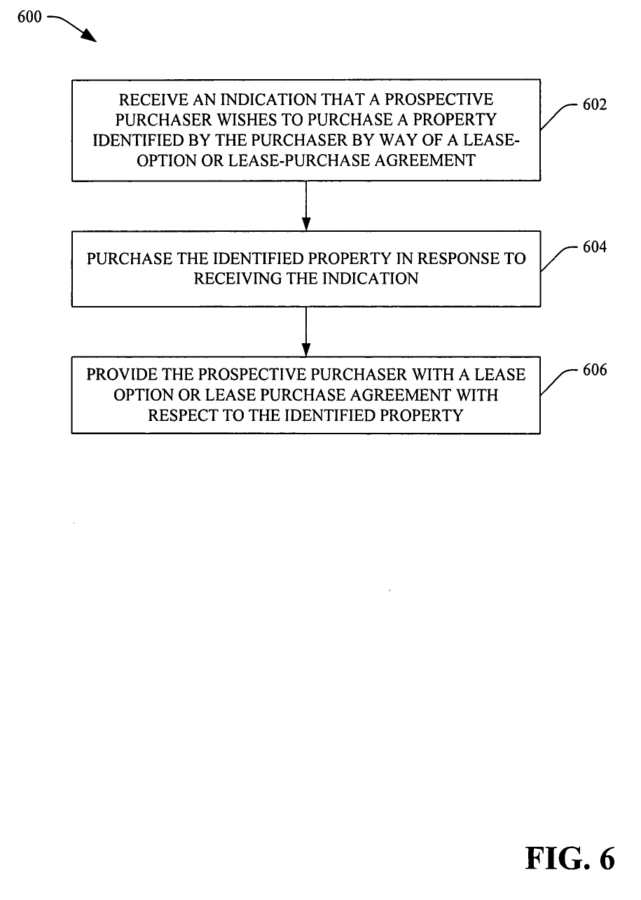

With reference now to FIGS. 6-10, various methods are illustrated that describe several aspects relating to lease option or lease purchase agreements. It is to be understood that, in some methods, one or more of the acts therein may be executed in full or in part upon a computer.

Referring specifically to FIG. 6, an example method 600 for providing a prospective purchaser with a lease option or lease purchase agreement is illustrated. At 602, an indication that a prospective purchaser wishes to purchase a property identified by the purchaser by way of a lease option or lease purchase agreement is received. At 604, the identified property is purchased in response to receiving the indication. At 606, the prospective purchaser is provided with a lease option or lease purchase agreement with respect to the identified property.

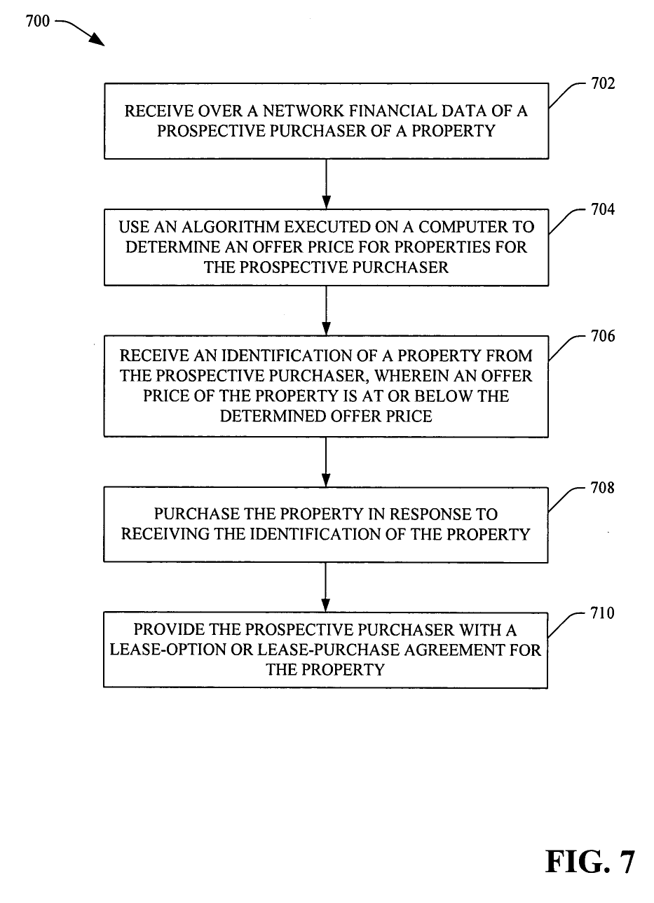

Now turning to FIG. 7, an example method 700 for providing a prospective purchaser with a lease option or lease purchase agreement is illustrated. At 702, financial data of a prospective purchaser of a property is received over a network (e.g., a digital network). At 704, an algorithm is used to determine a maximum offer price for properties for the prospective purchaser, wherein the algorithm is executed on a computer. The determined offer price is based at least in part upon the financial data received at 702. At 706, an identification of a property is received from the prospective purchaser, wherein an offer price of the property is at or below the determined maximum offer price. At 708, the property is purchased in response to receiving the identification of the property. At 710, the prospective purchaser is provided with a lease-option or lease-purchase agreement for the property.

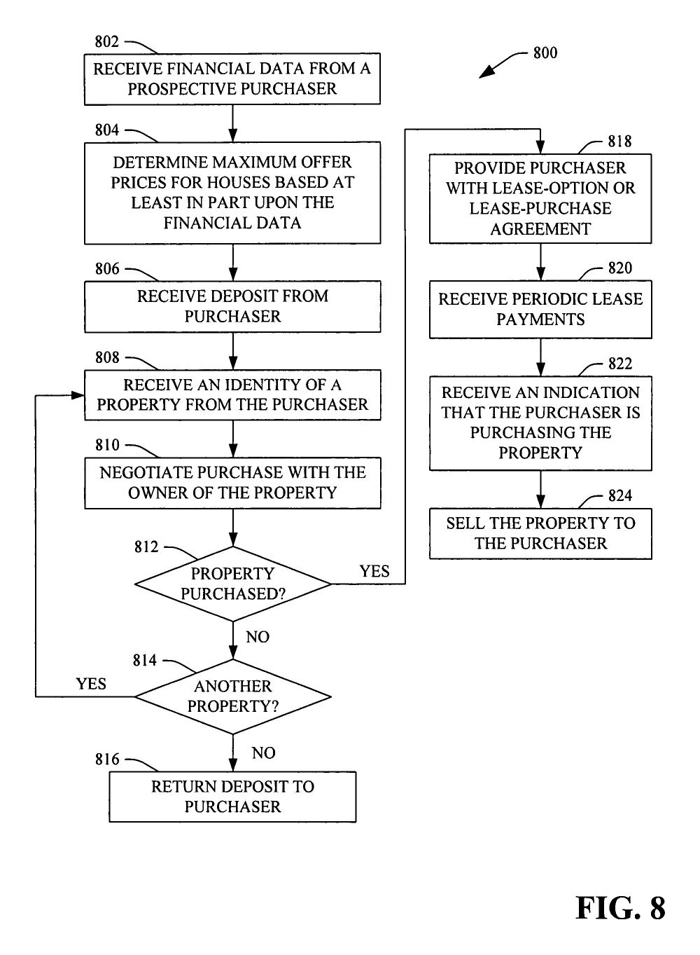

With reference now to FIG. 8, an example method 800 for selling a property by way of a lease option or lease purchase agreement is illustrated. At 802, financial data is received from a prospective purchaser. At 804, a maximum offer price for houses that can be purchased by the prospective purchaser is determined based at least in part upon the received financial data. At 806, a deposit is received from the prospective purchaser. At 808, an identity of a property is received from the purchaser.

At 810, the purchase of the property is negotiated with the owner of the property. At decision block 812, it is determined whether the property has been purchased. If the property has not been purchased (e.g., the negotiations failed), a determination is made regarding whether another property has been identified by the prospective purchaser at decision block 814. If another property has not been identified, the deposit received at 806 is returned to the purchaser 816. If another property has been identified by the prospective purchaser, then the method proceeds to 808.

If the property is purchased at 812, then at 818 the prospective purchaser is provided with a lease option or lease purchase agreement. At 820, periodic lease payments are received (e.g., monthly lease payments). At 822, an indication that the prospective purchaser is purchasing the property is received. For instance, the purchaser may exercise the option in the lease option agreement. In another example, the term of the lease purchase agreement may be reached. At 824, the property is sold to the purchaser.

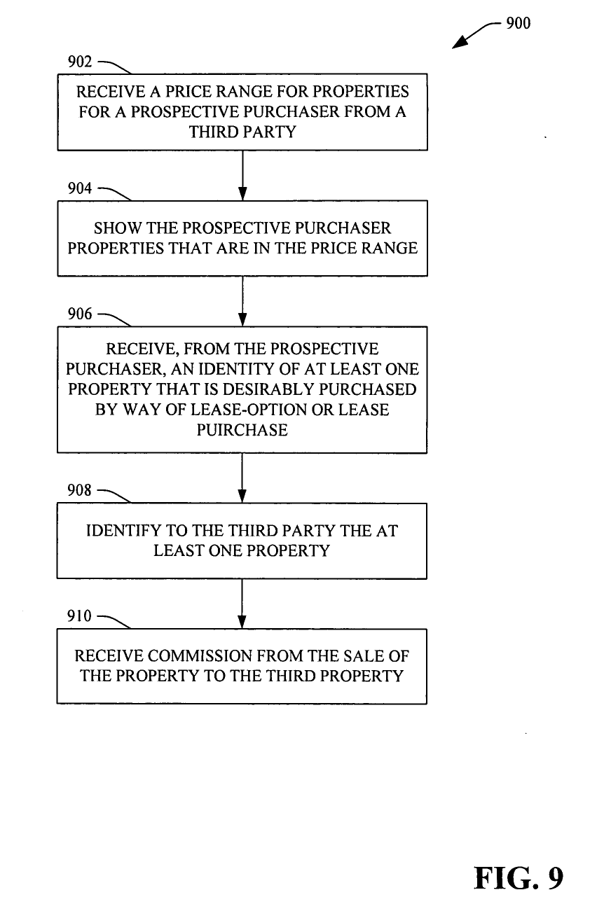

Now referring to FIG. 9, a method 900 relating to the sale of real estate by way of a lease option or lease purchase agreement utilizing a realtor by the purchaser is illustrated. At 902, a price range for properties that may be searched for by a prospective purchaser is received from a lessor. At 904, the prospective purchaser is shown properties that are in the price range by the realtor. At 906, an identity of at least one property that is desirably purchased by way of a lease option or lease purchase agreement is received. At 908, the at least one property is identified to the lessor. At 910, commission is received by the realtor from the sale of the property to the lessor.

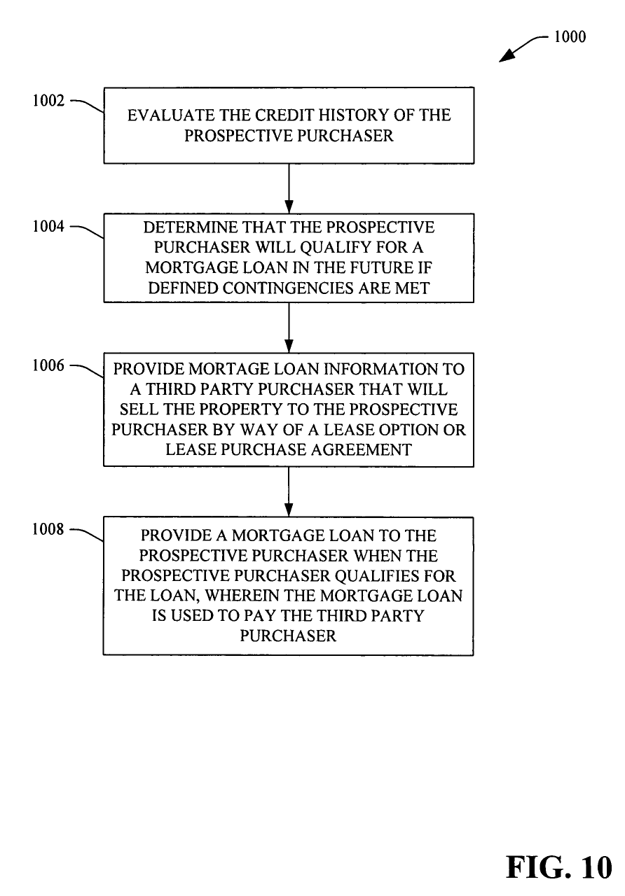

Turning now to FIG. 10, a method 1000 relating to the purchase of a property by way of a lease option or lease purchase agreement is illustrated. At 1002, the credit history of a prospective purchaser is evaluated. At 1004, it is determined that the prospective purchaser will qualify for a mortgage loan a certain time into the future if defined contingencies are met (e.g., credit cards paid in a timely manner over a two year period). At 1006, mortgage loan information with respect to the prospective purchaser is provided to a lessor. The lessor will purchase a home and later sell the home to the prospective purchaser by way of a lease option or lease purchase agreement. At 1008, a mortgage loan is provided to the prospective purchaser when the prospective purchaser qualifies for the loan, wherein proceeds of the loan are used to purchase the property from the lessor.

As noted above, one or more of the acts in this method may occur on a computer. For instance, a computer may be used in connection with evaluating a credit history. For example, the computer may have an algorithm stored thereon that uses financial data provided by the purchaser in connection with evaluating the purchaser's credit history. Furthermore, an algorithm may be executed by a processor on a computer in connection with determining a mortgage loan amount the prospective purchaser will qualify for in the future.

It is noted that several examples have been provided for purposes of explanation. These examples are not to be construed as limiting the hereto-appended claims. Additionally, it may be recognized that the examples provided herein may be permutated while still falling under the scope of the claims.

What is claimed is:

1. A method, comprising:
receiving an indication that a prospective purchaser wishes to purchase a property identified by the purchaser by way of a lease-option or lease-purchase agreement;
in response to receiving the indication, purchasing the identified property; and
providing the prospective purchaser with a lease option or lease purchase agreement with respect to the identified property.

2. The method of claim 1, wherein the property is a single family residence or a residential unit having four or less rentable units.

3. The method of claim 1, further comprising:
receiving financial data from the prospective purchaser;
determining, based at least in part upon the received financial data and a desired profit, an offer price for properties for the prospective purchaser; and
instructing the prospective purchaser to search for properties that are listed at or below the determined offer price.

4. The method of claim 3, wherein the financial data includes:
a deposit amount that the prospective purchaser is to provide; and
a periodic payment the prospective purchaser will make over the course of a defined time period.

5. The method of claim 4, further comprising:
storing the financial data on a computer; and
using an algorithm executed by the computer to determine the offer price, wherein the offer price is based at least in part upon the stored financial data.

6. The method of claim 3, further comprising:
determining a deposit that is to be paid by the prospective purchaser prior to purchasing the identified house; and
receiving from the prospective purchaser a deposit that is greater than or equal to the determined deposit prior to purchasing the identified property.

7. The method of claim 3, further comprising:
receiving an annual income of the prospective purchaser;
evaluating credit history for the prospective purchaser;
estimating an amount for a mortgage loan that the prospective purchaser will be approved for after lapse of an option period based at least in part upon the credit history and the annual income; and
determining the offer price based at least in part upon the determined amount for the mortgage loan.

8. The method of claim 7, wherein the option period is two years.

9. The method of claim 1, further comprising determining a price that the prospective purchaser will pay for the property upon the prospective purchaser exercising an option in the lease option or lease purchase agreement.

10. The method of claim 1, further comprising:
receiving a plurality of properties identified by the prospective purchaser; and
negotiating a purchase price for each of the plurality of properties.

11. The method of claim 1, further comprising:
receiving a deposit from the prospective purchaser; and
using at least a portion of the deposit as earnest money for the purchase of the property.

12. The method of claim 1, wherein the lease-option or lease-purchase includes terms for an option consideration, terms for a periodic payment, an option term, and terms for an option to purchase the property at an exercise price for the duration of the option term.

13. The method of claim 1, further comprising selling the property to the prospective purchaser in accordance with the lease-option or lease-purchase agreement.

14. The method of claim 13, wherein the act of selling comprises execution and delivery of a purchase agreement.

15. The method of claim 14, wherein the act of selling comprises transferring title of the property to the prospective purchaser.

16. A method, comprising:
receiving over a network financial data of a prospective purchaser of a property; and
receiving over a network desired geographic and house attribute data of a prospective purchaser of a property;
using an algorithm that is executed on a computer to determine an offer price, wherein the offer price is based at least in part upon the received financial data;
receiving an identification of a property from the prospective purchaser, wherein an offer price of the property is at or below the determined offer price;
purchasing the property in response to receiving the identification of the property; and
providing the prospective purchaser with a lease-option or lease-purchase agreement for the property.

17. The method of claim 16, wherein the lease-option or lease-purchase agreement includes terms for consideration, terms for periodic payments, and terms for an option exercise price.

18. The method of claim 16, wherein the received financial data includes a deposit amount and a periodic payment amount.

19. The method of claim 16, further comprising selling the property to the prospective purchaser upon the prospective purchaser exercising the lease-option.

20. The method of claim 16, further comprising receiving a deposit from the prospective purchaser prior to purchasing the property.

21. The method of claim 20, further comprising using the deposit as earnest money for purchasing the property.

22. The method of claim 20, further comprising using the deposit as at least a portion of a down payment on the property.

23. A method, comprising:
receiving a price range for properties for a prospective purchaser from a lessor;
showing the prospective purchaser properties that are in the price range;
receiving, from the prospective purchaser, an identity of at least one property that is desirably purchased by way of lease-option or lease-purchase; and
identifying to the lessor the at least one property.

24. A method, comprising:
evaluating a credit history of a prospective purchaser or a property;
determining a mortgage loan amount the prospective purchaser will qualify for at a time in the future if certain contingencies are met;
providing the determined mortgage amount to a lessor, wherein the lessor agrees to sell the property to the prospective purchaser by way of a lease option or lease purchase agreement; and
providing a mortgage loan to the prospective purchaser when the prospective purchaser qualifies for the mortgage loan.

25. A method, comprising:
receiving financial data from a prospective purchaser of a single family residence, wherein the prospective purchaser wishes to purchase a single family residence by way of a lease option or lease purchase agreement and the financial data includes an amount of a deposit the prospective purchaser can afford to put down and a periodic payment the prospective purchaser can afford to make;
providing the prospective purchaser with an offer price, wherein the prospective purchaser may search for single family residences that are at or below the offer price;
receiving an identity of one or more single family residences from the prospective purchaser;
executing and delivering a term sheet to the prospective purchaser, wherein terms of the term sheet include an amount of a deposit required from the prospective purchaser;
receiving a deposit that accords to the terms of the term sheet;
purchasing one of the identified single family residences;
executing and delivering a lease agreement for the identified single family residence;
executing and delivering an option agreement for the identified single family residence;
receiving a purchase price for the identified single family in accordance with terms of the option agreement; and
transferring title of the single family residence to the prospective purchaser.
